(19) United States
(12) Patent Application Publication
(10) Pub. No.: US 2009/0126088 A1
(43) Pub. Date: May 21, 2009

(54) PROTECTIVE GARMENT FOR USE WITH RADIATION MONITORING DEVICES

(76) Inventors: Sudhansu S. Yadav, Carmel, IN (US); Joseph T. Marcum, Noblesville, IN (US); Mark Dieterle, Noblesville, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 12/192,097

(22) Filed: Aug. 14, 2008

Related U.S. Application Data
(60) Provisional application No. 60/955,718, filed on Aug. 14, 2007.

(51) Int. Cl. A41D 13/00; D05B 23/00; G21F 3/02

(52) U.S. Cl. 2/457; 112/475.09; 250/516.1

(57) ABSTRACT

A nonwoven disposable safety garment made by cutting at least one sheet of nonwoven material into a safety garment pattern, stitching the at least one sheet to define a garment, and hemming the garment. Cut edges are twice folded and hemmed under to prevent exposure of any cut edges. Stitching is characterized by a stitch density in the range of 10 to 12 stitches per inch. Attachment features, such as pockets, sleeves, and loops, are provided for dosimeters and other monitoring equipment. Some attachment features may be used by the wearer to remove the garment, either in a pull-off or tear-off fashion.

### REFERENCE TO RELATED APPLICATIONS

The present application claims priority to U.S. patent application Ser. No. 11/428,728 (“APPARATUS AND METHOD FOR PACKAGING NONWOVEN SAFETY GARMENTS”), filed Jul. 5, 2006, pending; its parent, U.S. application Ser. No. 10/798,646 (“DISPOSABLE GARMENT WITH REDUCED PARTICULATE SHEDDING”), filed Mar. 11, 2004, now abandoned; and Provisional Application No. 60/955,718 (“NUCLEAR QPA SUIT”), filed Aug. 14, 2007, pending. Each of these is incorporated by reference as if fully set forth herein.

### TECHNICAL FIELD

The present invention relates generally to the field of safety apparel, and more specifically to a safety garment having reduced particulate shedding properties, dosimeter attachment facilities, reinforced points of wear, and ease-of-removal characteristics.

### BACKGROUND

Safety garments, such as disposable smocks, jumpsuits, gloves, shoe coverings, and hair coverings, are required apparel for the performance of many jobs. Some of the jobs requiring safety garments are performed in clean room environments, wherein the introduction of foreign matter must be minimized. For example, technicians in certain sensitive medical fields dealing with infectious matter, aerospace researchers assembling interplanetary probes, and material scientists developing and manufacturing ultrapure materials all wear safety garments in clean room environments. The safety garments perform the dual function of protecting the wearer from the potentially hazardous materials he is working with as well as preventing unwanted matter from the wearer's person from contaminating his work product.

Safety garments for use in clean room environments are typically made from nonwoven disposable materials, such as from sheets of spunbond/melt blown/melt blown/spunbond (SMMS) material and the like. Such sheets of material are cut into patterns and stitched together to form desired safety apparel. Typically, as these garments are intended to be disposable and the focus is on their functionality and not aesthetic appeal, little attention is paid to the hemming and stitching. The “as cut” edges are thus exposed. However, in clean room environments where contaminant levels in the parts per million or even parts per billion would be too high, such exposed cut edges present genuine sources of potential particulate contamination.

Moreover, as these garments are intended to be disposable, little effort is made to provide durable stitching. The prevalent attitude is that a garment intended to be worn for just a few hours does not require superior stitching. However, in a clean room situation or a hazardous environment such as asbestos remediation or nuclear demolition and decontamination, seam separation is not only a potential source of particulate evolution in and of itself, but also produces a pathway from the exterior to the interior of the garment through which potentially hazardous material may flow.

Many workplace environments from industrial settings to hospitals hold the potential to expose workers to various types of radiation. One problem faced by workers in such environments is how to safely perform tasks while monitoring their exposure to potentially harmful radiation. Often such protective measures include the use of personal radiation measuring devices referred to as “dosimeters” along with protective garments.

Traditionally, personal dosimeters have been attached to a worker's protective garments using tape or some other improvised means. Under normal working conditions, such informal attachment methods often lead to the detachment and potential loss or damage to the dosimeter device. Additionally, such protective garments are often bulky and difficult to remove when they are no longer needed.

There thus remains a need for an improved safety garment that is more durable and less prone to particulate shedding. There is also a need for protective garments to which personal dosimeter devices and other monitoring equipment can be effectively attached, as well as a garment that can be removed quickly and easily, and withstands high-wear regions such as elbows and knees. The present disclosure addresses these needs.

### SUMMARY

The present disclosure relates to a disposable clean room safety garment, including at least one sheet of nonwoven fabric having at least one cut edge, a plurality of stitches formed in the sheet(s) of nonwoven fabric to define a garment; and hemming formed at cut edges. The nonwoven fabric is preferably formed from spunbond/melt blown material. The stitching is characterized by an optimized stitch density of between ten and twelve stitches per inch. The garment includes at least one dosimeter attachment feature for holding or attaching one or more dosimeters to the garment. These may be positioned to allow the wearer to grasp them and tear open certain seams or otherwise remove the garment.

One object of the present invention is to provide an improved safety garment. Related objects and advantages of the present invention will be apparent from the following description.

### BRIEF DESCRIPTION OF THE DRAWINGS

FIG. 1 is a perspective view of a safety garment in a first embodiment.

FIG. 2 is an enlarged exploded partial view of a hemmed edge of the embodiment of FIG. 1.

FIG. 3 is a perspective view of a safety garment in a second embodiment of the disclosed technology.

FIG. 4 is a perspective view of a safety garment in a third embodiment of the disclosed technology.

FIG. 5 is a perspective view of a safety garment in a fourth embodiment of the disclosed technology.

FIG. 6 shows a protective garment according to a fifth embodiment of the disclosed technology.

FIG. 7 shows a protective garment according to a sixth embodiment of the disclosed technology.

FIG. 8 shows a closure for a protective garment according to a seventh embodiment of the disclosed technology.

### DESCRIPTION

For the purposes of promoting an understanding of the principles of the disclosure and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated embodiments and such further applications of the principles of the invention as illustrated therein being contemplated as would normally occur to one skilled in the art.

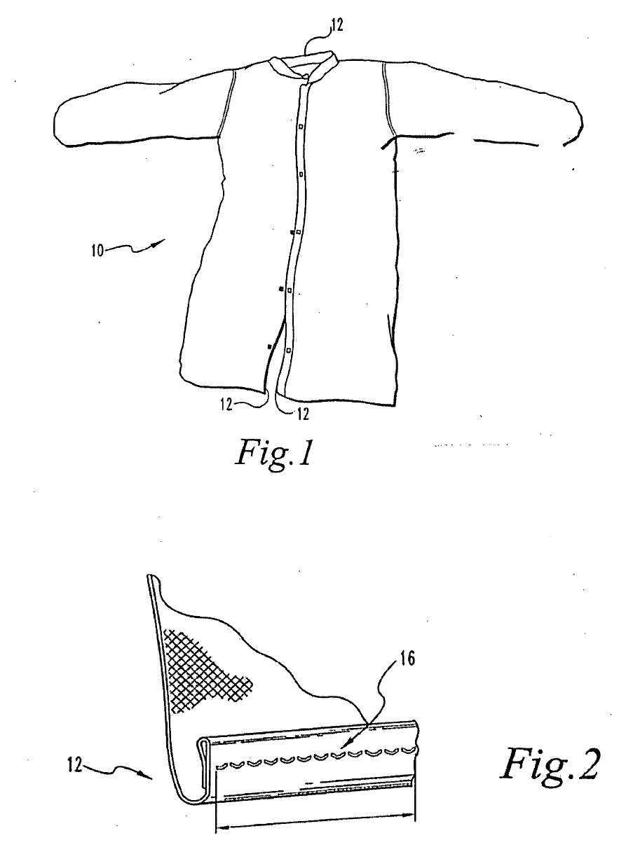

FIGS. 1 and 2 illustrate a first embodiment of the disclosed technology, a reduced particulate shedding disposable nonwoven safety garment 10. In this embodiment, safety garment 10 is formed as a smock. Safety garment 10 is preferably made from spunbond/melt blown/melt blown/spunbond (SMMS) material, spunbond/melt blown/spunbond (SMS) material, or the like, and includes double-folded and hemmed edges 12. The edges 12 are folded such that all cut edges of the non-woven material are double-folded under so as not to be exposed. Non-exposure of the edges 12 thus greatly reduces the potential for generation of shed particles where the material was cut. The seams 16 are stitched with an optimization of the number of stitches per inch (SPI), increased to 10-12 SPI over the standard 6-8 SPI. Stitch densities of 10-12 SPI have been found to be better than the lower range, as densities greater than 12 SPI weaken the non-woven material via excessive perforation and those less than 10 SPI provide a looser and weaker hem, such that particulate shedding is not minimized.

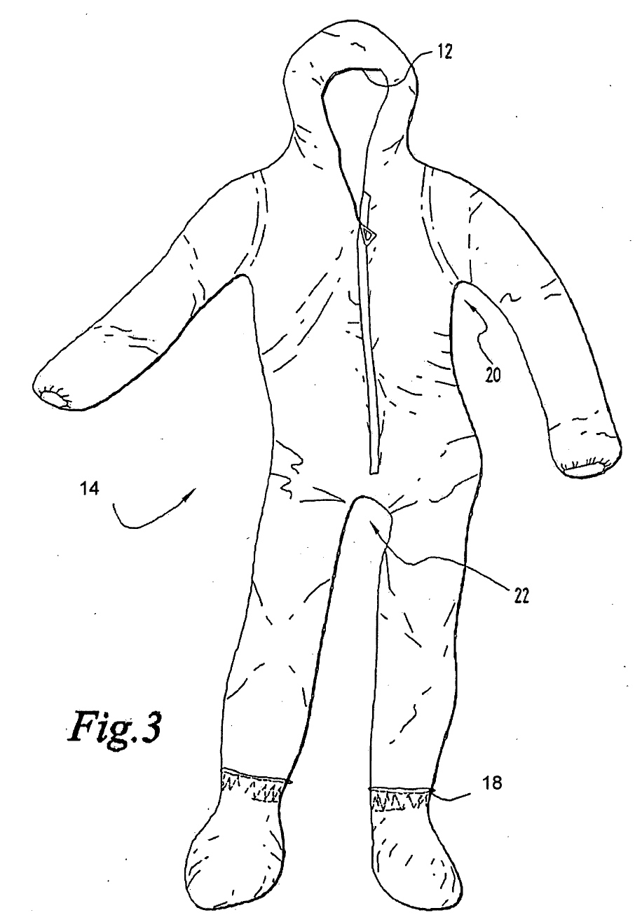

FIG. 3 illustrates a second embodiment of the present invention, a jumpsuit 14 made from spunbond/melt blown/melt blown/spunbond (SMMS) material, spunbond/melt blown/spunbond (SMS) material, or the like. The jumpsuit 14 includes twice-folded and hemmed edges 12. As in the first embodiment, the edges 12 are folded such that all cut edges of the non-woven material are double-folded under so as not to be exposed. The seams 16 in this embodiment are stitched with an increased stitch density of 10-12 SPI over the standard 6-8 SPI. The garment also includes foot coverings 18 that are preferably stitched to the garment but may alternately be individually formed and attached, such as by an elastic band stitched into the hem at the foot opening. The garment 14 further includes an excess of material in the armpit 20 and groin/seat area 22, to minimize the risk of accidental tearing that might generate additional particulate matter that enters into the environment, and might expose the wearer to environmental hazards.

In practice, the garments 10 and 14 are made by cutting one or more sheets of nonwoven material into a desired safety garment pattern. Simple patterns (e.g., shoe coverings) may require a single sheet; more complex patterns (e.g., smocks, jumpsuits, and the like) may require two or more sheets of varying size. The sheet(s) is/are then stitched together to define a garment 10. The edges of the garment 10 are then hemmed. All cut edges are twice folded and hemmed under to prevent exposure of any cut edges that could increase the likelihood of particulate shedding. All stitching in these illustrative embodiments is characterized by a stitch density in the range of 10 to 12 stitches per inch.

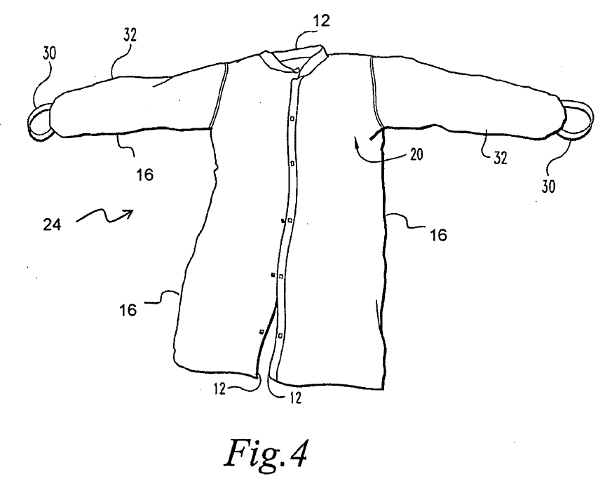

FIG. 4 illustrates a third embodiment garment 24. The garment 24 of FIG. 4 is similar to that described in FIG. 1, but with the addition of loops 30 affixed to the sleeve 32 portion of the garment 24, to engage a wearer's hands so as to keep the garment 24 positioned about the wearer's body. In this embodiment, as in the foregoing embodiment of FIG. 1, the safety garment 24 is formed as a smock and is preferably made from spunbond/melt blown/melt blown/spunbond (SMMS) material, spunbond/melt blown/spunbond (SMS) material, or the like. The garment 10 includes double-folded and hemmed edges 12. The edges 12 are folded such that all cut edges of the non-woven material are double-folded under so as to not be exposed. Non-exposure of the edges 12 thus greatly reduces the potential for generation of shed particles where the material was cut. The loops 30 are likewise folded over and stitched such that there are no exposed cut edges. The seams 16 are stitched with an optimization of the number of stitches per inch (SPI), increased to 10-12 SPI over the standard 6-8 SPI.

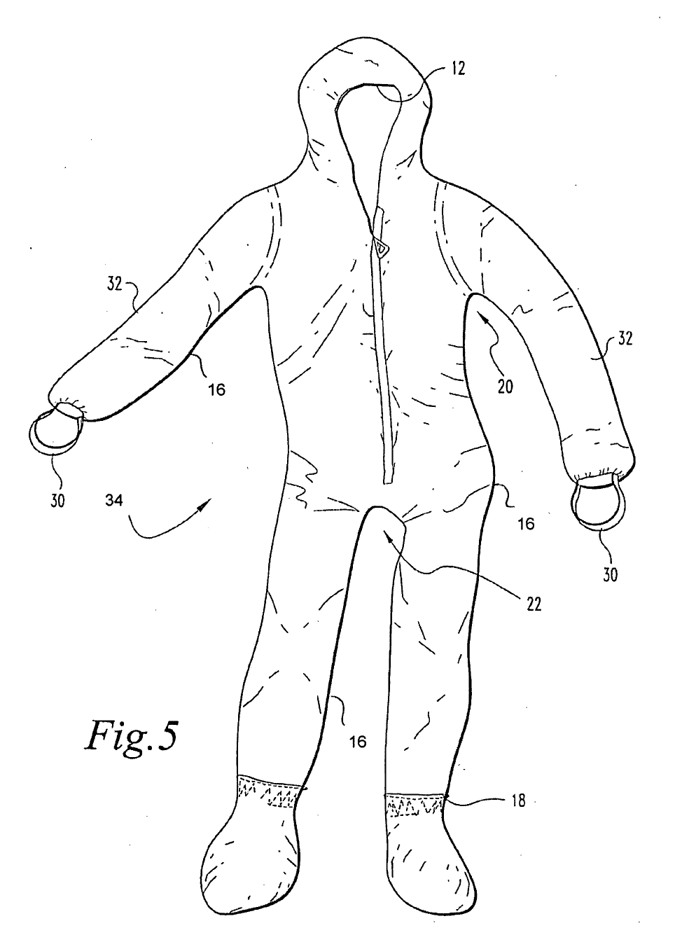

FIG. 5 illustrates a fourth embodiment, a jumpsuit 34 similar to that of FIG. 3 with the addition of loops 30 extending from the sleeve portion 32 of the garment 34 to engage the hands of a wearer (similar to the embodiment of FIG. 4). The jumpsuit 34 is likewise preferably made from spunbond/melt blown/melt blown/spunbond (SMMS) material, spunbond/melt blown/spunbond (SMS) material, or the like. The jumpsuit 34 includes twice-folded and hemmed edges 12. As in the first embodiment, the edges 12 are folded such that all cut edges of the non-woven material are double-folded under so as to not be exposed. The loops 30 are likewise formed of the SMMS, SMS or the like and folded over and stitched such that the cut edges are not exposed. The seams 16 are stitched with 10-12 SPI. The garment also includes foot coverings 18 that are preferably stitched to the garment, but may alternately be individually formed and attached, such as by an elastic band stitched into the hem at the foot opening. The garment 12 further includes an excess of material in the armpit 20 and groin/seat area 22, to minimize the risk of accidental tearing that might generate additional particulate matter into the environment as well as expose the wearer to environmental hazards.

The loops of the embodiments of FIGS. 4 and 5 are preferably formed with no exposed cut edges 12. In particular, each loop 30 is preferably formed from an elongated piece of cut nonwoven fabric defining a pair of generally parallel cut edges 12, and wherein the cut edges 12 are folded under and hemmed into place such that the cut edges 12 are not exposed.

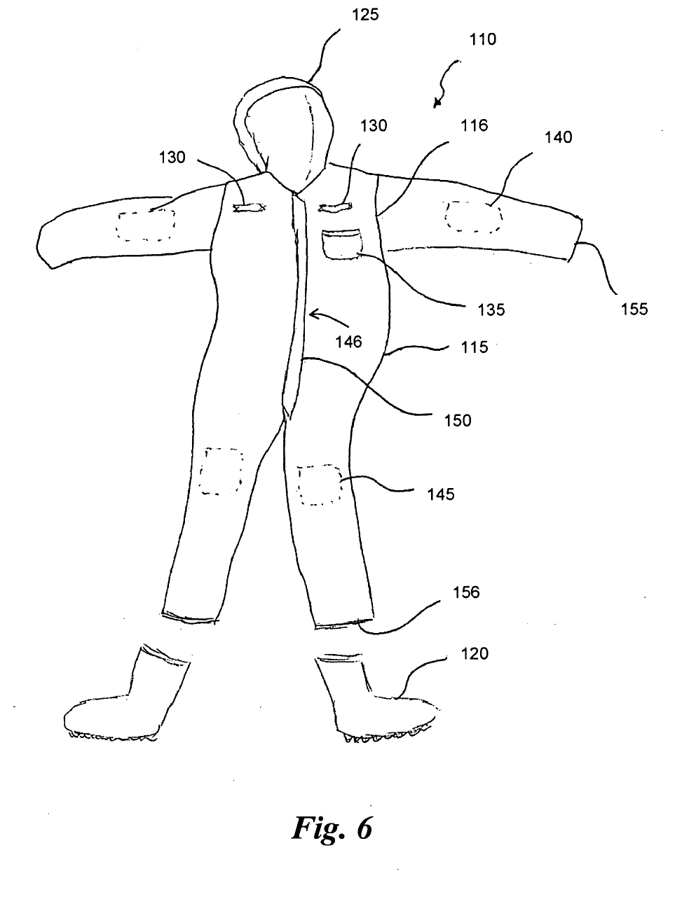

FIG. 6 illustrates a protective garment 110 for use with a radiation monitoring device according to one embodiment of the disclosed technology. In this particular embodiment, the garment 110 is a jumpsuit or coverall-type garment having a hood portion 125 and a body portion 115. This particular embodiment also includes separate boots 120, although other embodiments may include integrated foot coverings. Still other embodiments may include integrated hand coverings. The arm openings 155 and the leg openings 156 in this particular embodiment are hemmed so as to reduce shredding of the garment material. Optionally, the edges at arm openings 155 and the leg openings 156 are double-folded and hemmed such that all cut edges are double-folded under so as to not be exposed. Non-exposure of the edges greatly reduces the potential for generation of shed particles where the material was cut. In other embodiments, the arm openings 155 and/or leg openings 56 further include elastic bands so as to ensure a tight fit.

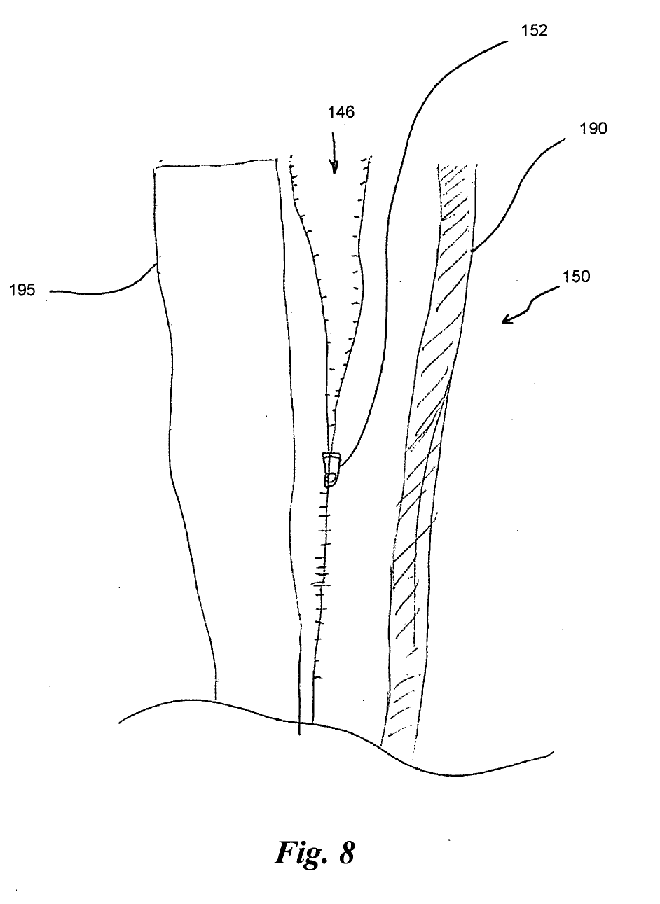

Garment 110 is accessible through opening 146, which is held closed using a closure means 150 shown in greater detail in FIG. 8. In this particular example, closure means 150 includes a zipper 152. In other examples, closure means 150 includes snaps, buttons, hook-and-loop closure materials such as Velcro®, adhesive strips, or any other suitable closure means. Additionally, closure means 150 further includes a cover flap 195 capable of being folded over once opening 146 is closed using zipper 152. Cover flap 195 prevents material from entering garment 110 through zipper 152. Flap 195 is releasably held in the closed position by a securing strip 190, which may comprise hook-and-loop closure materials such as Velcro®, adhesive strips, or any other suitable securing means.

Garment 110 can be made from a non-woven material such as polypropylene, polyethylene, polyester materials, and the like, including combinations of two or more non-woven materials. Such materials may be manufactured using spunbond/melt blown/melt blown/spunbond (SMMS) techniques, spunbond/melt blown/spunbond (SMS) techniques, or other suitable techniques for manufacturing non-woven garments, and may include two or more layers of material and/or multiple layers of different materials, as desired. The seams 116 located at various points about the garment 110 are optionally double-folded under so as not to be exposed. The seams 116 are also stitched with an optimized number of stitches per inch (SPI) increased to 10-12 SPI over 6-8 SPI, which is the industry standard. A stitch density of 10-12 SPI has been found to be optimal, as more than 12 SPI weakens the non-woven material via excessive perforation and less than 10 SPI provides a looser and weaker hem, such that particulate shedding is not minimized. Optionally, seams 16 are formed using some other method such as sonic welding or binding.

Continuing with the embodiment shown in FIG. 6, garment 110 further includes at least one dosimeter attachment feature 130. In this particular example, garment 110 includes two dosimeter attachment features 130 located near the garment shoulders on its front side. Other embodiments include a greater or lesser number of dosimeter attachment features positioned at other locations about the garment, such as the arms, wrists, or waist area, as desired. Dosimeter attachment features 130 are shown as loops or straps affixed to garment 110 using box-type stitches. In other examples, dosimeter attachment features 130 have a different configuration such as a sleeve, pouch, pocket, or the like, and are attached using a different type of stitching or a different attachment means such as adhesives, snaps, ties, and the like. Optionally, garment 110 includes further monitoring and/or communication devices in addition to dosimeters, such as body temperature monitoring devices, radios, pulse rate monitors, and the like.

In one embodiment of the disclosed technology, garment 110 is constructed such that one or more seams are designed to rip or tear when a force above a predetermined threshold is applied. Such “tear-away” garments are known in the industry and are designed so as to allow for easy removal of a garment when it is no longer needed. Tear away garments allow workers to quickly and easily remove a garment at the end of a shift, for example. Attachment features 130 are optionally positioned so as to allow a wearer to grasp one or both of them and strong enough such that pulling on the attachment features 130 causes the tear away seams to release, thereby allowing the worker to quickly and easily remove the garment 110. Alternatively, a garment 110 according to another embodiment of the disclosed technology will open at the closure means 150 when sufficient force is applied by the wearer to the attachment features 130, thereby allowing the wearer to remove the garment 110.

Portions of garment 110 likely to experience wear such as the knees and elbows may include reinforced portions 140, 145. Reinforced portions 140, 145 may be made from the same material as garment 110 or from a different, stronger material. Optionally, garment 110 may be made from two or more layer of material. Reinforced portions 140, 145 may be attached to the interior or exterior surface of garment 110 and may be attached using adhesives, stitching, or any other suitable attachment method. Garment 110 may also include one or more pockets 135 located about the garment as desired.

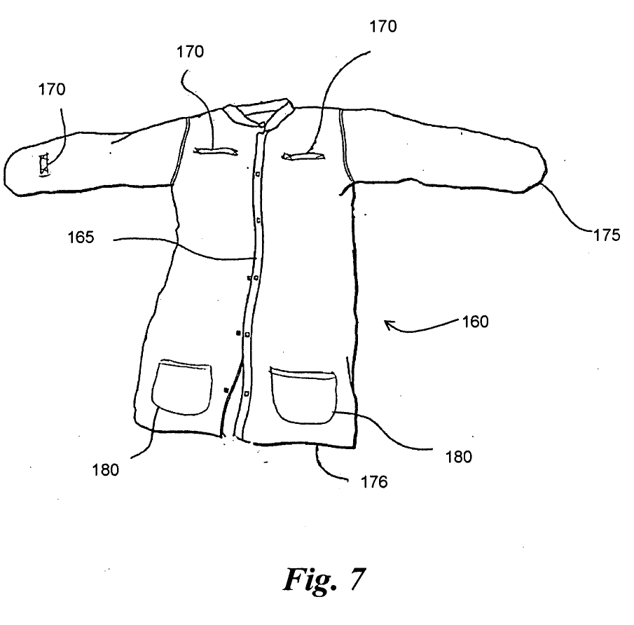

FIG. 7 shows an alternative embodiment of a garment 160 designed to be worn in environments where a worker may be exposed to radiation. In this particular example, garment 160 is a smock or apron having two sleeves 175 and an open bottom portion 176 that extends down the wearer's torso. Garment 160 is closed using a closure means 165 (shown in this particular example as snaps). In other examples, closure means 165 may take the form of a zipper, buttons, adhesive strips, or any other suitable closure means. Garment 160 further includes two pockets 180 located near bottom portion 176, although other embodiments may include more or fewer pockets located at different points about garment 160.

Continuing with the embodiment shown in FIG. 7, garment 160 further includes at least one dosimeter attachment feature 170. In this particular example, garment 160 includes two dosimeter attachment features 170 located near the garment shoulders and one attachment feature 170 located on a sleeve. Other embodiments include a greater or lesser number of dosimeter attachment features positioned at other locations on the garment such as the arms, wrists, or waist area as desired. Dosimeter attachment features 170 are shown as loops or straps affixed to garment 160 using box-type stitches. In other examples, dosimeter attachment features 170 have a different configuration such as a sleeve, pouch, pocket, or the like, and are attached using a different type of stitching or a different attachment means such as adhesives, snaps, ties, and the like. Optionally, garment 160 includes further monitoring and/or communication devices in addition to dosimeters such as body temperature monitoring devices, radios, pulse rate monitors, and the like.

While the disclosed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a near infinite number of insubstantial changes and modifications to the above-described embodiments, and that it would be impractical to attempt to describe all such variations in the present specification. Accordingly, it is understood that all changes and modifications that come within the spirit of the disclosed technology are desired to be protected.

1. A nonwoven safety garment, comprising:
a piece of cut spunbond/melt blown material having a plurality of cut edges;
at least one seam connecting at least two of the plurality of cut edges, together defining a garment; and
a dosimeter attachment feature configured to removably attach a dosimeter to the garment;
wherein, at one or more cut edges that are not connected at the at least one seam, the cut edges are double-folded under, then hemmed into place.

2-4. (canceled)

5. The garment of claim 1, wherein the dosimeter attachment feature is a loop of fabric sewn onto the garment.

6. The garment of claim 1, wherein
the seams are configured for tear-off removal of the garment, and
the attachment feature is further configured to be used by a wearer to tear off the garment.

7. A disposable clean room safety garment, comprising:
at least one sheet of nonwoven fabric having at least one cut edge;
a plurality of stitches formed in the at least one sheet of nonwoven fabric to define a garment with no lining;
hems formed at the at least one cut edge; and
a dosimeter attachment feature configured to removably attach a dosimeter to the garment;
wherein the nonwoven fabric is formed from spunbond/melt blown material; and
the plurality of stitches and the hems are characterized by stitch densities between ten and twelve stitches per inch.

8-12. (canceled)

13. The garment of claim 7, wherein the dosimeter attachment feature is
selected from the feature group consisting of a loop, a strap, a pouch, a pocket, and a sleeve, and
sewn onto the garment so that no cut edge is exposed.

14. The garment of claim 7, wherein
the seams are configured for tear-off removal of the garment, and
the attachment feature is further configured to be used by a wearer to tear off the garment.

15. A method of making a safety garment, comprising the steps of:
a) cutting at least one sheet of nonwoven material into a safety garment pattern;
b) stitching the at least one sheet to define a garment;
c) hemming the garment;
d) attaching a hand-engaging loop to the garment; and
e) attaching to the garment a dosimeter attachment feature configured to removably attach a dosimeter to the garment;
wherein all cut edges are twice folded and hemmed under to prevent exposure of any cut edge; and
wherein all stitching and hemming is characterized by a stitch density in the range of 10 to 12 stitches per inch.

16. (canceled)

17. The method of claim 15, wherein the dosimeter attachment feature is a loop of fabric sewn onto the garment.

18. The method of claim 15, wherein
the seams are configured for tear-off removal of the garment, and
the attachment feature is further configured to be used by a wearer to tear off the garment.

19. A nonwoven safety garment for wearing during possible exposure to radiation, comprising:
a piece of cut spunbond/melt blown material having a plurality of cut edges;
at least one seam connecting at least two of the plurality of cut edges, together defining a garment; and
a dosimeter attachment feature configured to removably attach a dosimeter to the garment.

20. The garment of claim 19 wherein, where the cut edges are not connected at the at least one seam, the cut edges are double-folded under, then hemmed into place.
